(19) United States
(12) Patent Application Publication
(10) Pub. No.: US 2002/0002656 A1
(43) Pub. Date: Jan. 3, 2002

(54) INFORMATION PROCESSING SYSTEM

(76) Inventors: ICHIKI HONMA, HADANO-SHI (JP); HIROSHI KUROKAWA, HADANO-SHI (JP); TOSHIAKI KAWAMURA, HADANO-SHI (JP); EIJI NOMURA, HADANO-SHI (JP)

Correspondence Address: ANTONELLI TERRY STOUT AND KRAUS, SUITE 1800, 1300 NORTH SEVENTEENTH STREET, ARLINGTON, VA, 22209

(21) Appl. No.: 09/015,319

(22) Filed: Jan. 29, 1998

(30) Foreign Application Priority Data
Jan. 29, 1997 (JP) 09-15496

(51) Int. Cl. G06F 12/08

(52) U.S. Cl. 711/122; 711/143; 711/142

(57) ABSTRACT

An information processing system and a multi-level hierarchical storage device for use in the information processing system having a plurality of instruction processors and a plurality of main storage devices. The multi-level hierarchical storage device includes a first-cache storage device of a write-through type provided for each instruction processor, a second-cache storage device of a write-back type provided for each main storage device, and a third-cache storage device of a write-through type provided between the first-cache storage device and the second-cache storage device.

### BACKGROUND OF THE INVENTION

The present invention relates to an information processing system and a storage device for use in the information processing system. More particularly the present invention relates to an information processing system and a multi-level hierarchical storage device for use in the information processing system including a plurality of instruction processors and a plurality of main storage devices wherein the multi-level hierarchical storage device includes a plurality of hierarchically arranged storage devices of the write-through type.

In a conventional data processing system wherein buffer and work storage devices are used for holding a part of data stored in a main storage device, an access to data held in the buffer or work storage device is performed instead of accessing the main storage device. This kind of information processing system is therefore capable of reducing the number of accesses to the main storage device, resulting in enhancement in information processing performance.

FIG. 7 is a block diagram illustrating a configuration of the above-mentioned conventional information processing system. Referring to FIG. 7, there are shown main storage devices 10-1 and 10-2, work storage devices 11-1 and 11-2, buffer storage devices 12-1 and 12-2, instruction processors 13-1 and 13-2, and selectors 14-1 and 14-2.

The conventional information processing system shown in FIG. 7 includes instruction processors 13-1 and 13-2, buffer storage devices 12-1 and 12-2 serving as first-cache memories for respective instruction processors 13-1 and 13-2, main storage devices 10-1 and 10-2, and work storage devices 11-1 and 11-2 serving as second-cache memories for respective main storage devices 10-1 and 10-2.

In the conventional information processing system structured as mentioned above, a part of data stored in the main storage devices 10-1 and 10-2 is held in the work storage devices 11-1 and 11-2 respectively, and furthermore a part of data contained in each of the work storage devices 11-1 and 11-2 is held in the buffer storage devices 12-1 and 12-2. The buffer storage devices 12-1 and 12-1 are allocated to the instruction processors 13-1 and 13-2 respectively, and each of the instruction processors 13-1 and 13-2 accesses each of the buffer storage devices 12-1 and 12-2 respectively.

The work storage devices 11-1 and 11-2 are allocated to the main storage devices 10-1 and 10-2 respectively. Data held in the work storage device 11-1 and data held in the work storage device 11-2 are different from each other. More specifically, data having the same address does not reside in both of these work storage devices at a time.

The above-mentioned usage of work storage devices is particularly referred to as a single-copy method. In contrast a method in which data having the same address is held in a plurality of work storage devices at the same time is referred to as a multi-copy method.

In an arrangement that the information processing system structured as stated above uses the single-copy method for work storage, operations thereof are performed as described below.

Each of the instruction processors 13-1 and 13-2 accesses each of the buffer storage devices 12-1 and 12-2 to read out necessary data. If the necessary data is not found in the buffer storage device allocated to each instruction processor, the necessary data is transferred from one of the work storage devices 11-1 and 11-2 to the respective buffer storage device 12-1/12-2 according to address information. Thereafter, the instruction processor reads out the necessary data from the buffer storage device 12-1/12-2 having retrieved the necessary data. Further, if the necessary data is not found in the buffer storage device 12-1/12-2 allocated to each processor nor the work storage device 11-1/11-2, the necessary data is retrieved from one of the main storage devices 10-1 and 10-2 to the associated work storage device 11-1 or 11-2. Then, the necessary data is transferred from the work storage device to the buffer storage device 12-1/12-2, from which the necessary data is further transferred to the instruction processor to which it is allocated.

For rewriting any existent data stored in one of the main storage devices 10-1 and 10-2, the instruction processor 13-1 or 13-2 accesses the associated buffer storage device 12-1 or 12-2 to send new data to be written. Then, if a copy of the existent data of a write destination stored in the main storage device 10-1 or 10-2 is found in the buffer storage device 12-1 or 12-2, the new data is written for replacement. If not, the new data is ignored through interpretation that the writing of the new data to the buffer storage device 12/1 or 12/2 is not necessary.

In another method for rewriting any existent data stored in one of the main storage devices 10-1 and 10-2, new data to be written is sent to one of the work storage devices 11-1 and 11-2 via selector 14-1 or 14-2 associated with each instruction processor according to address information. The single-copy method is employed for the work storage devices 11-1 and 11-2. Thus, the selector 14-1 or 14-2 judges which of the work storage devices 11-1 and 11-2 should receive the new data to be written and then the new data is sent to one of the work storage devices according to the result of judgment. The work storage device 11-1 or 11-2 checks whether a copy of the existent data of a write destination stored in the main storage device 10-1 or 10-2 is found in itself. If the copy of the existent data of the write destination is found in the work storage device 11-1 or 11-2, the new data is written into the work storage device 11-1 or 11-2 for replacement. If a copy of the existent data of the write destination is not found in the work storage device 11-1 or 11-2, the copy of. the existent data of the write destination is transferred from the main storage device 10-1 or 10-2 to the work storage device 11-1 or 11-2 and thereafter the new data is written for replacement. In this fashion, the latest data is always held in the work storage device 11-1 or 11-2.

The first method for writing data to the buffer storage device 12-1 or 12-2 is referred to as a write-through method, and the second method for writing data to the work storage device 11-1 or 11-2 is referred to as a write-back method.

The conventional information processing system mentioned above includes three hierarchical levels of memory storage devices, namely: buffer storage level, work storage level, and main storage level. In this system configuration, with an increase in the number of machine cycles required for transferring read-out data from one of the work storage devices 11-1 and 11-2 to one of the buffer storage devices 12-1 and 12-2, a load of processing overhead for data transfer to the buffer storage device 12-1 or 12-2 increases if data of interest is not found in the buffer storage device. Also, in a situation that the number of instruction processors is increased, the total number of accesses from one of the buffer storage devices 12-1 and 12-2 to one of the work storage devices 11-1 and 11-2 increases to cause degradation in processing performance of the entire information processing system.

To solve the problems mentioned above, there is a known approach in which memory capacities of the buffer storage devices 12-1 and 12-2 are increased to increase a residential probability (hit rate) of necessary read-out data in the buffer storage. In general, however, since an access speed of memory storage decreases as a capacity thereof is increased, a certain limitation is imposed on increasing the capacities of buffer storage devices 12-1 and 12-2 that require high-speed accessing.

A technique intended for circumventing the above-mentioned disadvantage is found in “Nikkei Electronics” No. 6-17, pp. 213 to 226, issued in 1996. This conventional technique is explained below with reference to FIG. 8.

FIG. 8 is a block diagram showing another example of an information processing system configuration using the conventional technique. Referring to FIG. 8, there are shown work storage controllers 11-3 and 11-4, work storages 11-5 and 11-6, secondary buffer storage devices 20-1 and 20-2, secondary buffer storage controllers 20-3 and 20-4, and secondary buffer storages 20-5 and 20-6. Other reference numerals in FIG. 8 are the same as those indicated in FIG. 7.

In the conventional information processing system illustrated in FIG. 8 includes instruction processors 13-1 and 13-2, buffer storage devices 12-1 and 12-2 provided for respective instruction processors, secondary buffer storage devices 20-1 and 20-2 provided for respective buffer storage devices, main storage devices 10-1 and 10-2, and work storage devices 11-1 and 11-2 provided for respective main storage devices. In this exemplified system configuration, the work storage devices 11-1 and 11-2 and the secondary buffer storage devices 20-1 and 20-2 are of a write-back type, and the buffer storage devices 12-1 and 12-2 are of a write-through type.

In the conventional information processing system illustrated in FIG. 8, the buffer storage devices 12-1 and 12-2 indicated in FIG. 7 are provided with the write-back-type secondary buffer storage devices 20-1 and 20-2, serving as third-cache memories, respectively. In this arrangement, if necessary data is not found in the buffer storage device 12-1 or 12-2, the secondary buffer storage device 20-1 or 20-2 is referenced. Thereby, it becomes possible to reduce a probability of having to perform an access to the work storage device 11-1 or 11-2 or further to the main storage device 10-1 or 10-2 to obtain the necessary data. Also, since the write-back-type secondary buffer storage devices 20-1 and 20-1 in this conventional system can decrease the number of accesses to the work storage, a load of processing overhead is reduced to allow high-speed performance of processing even in a situation that the number of instruction processors is increased.

When the instruction processor 13-1 in the information processing system shown in FIG. 8 attempts to rewrite data in the buffer storage device 12-1 and the write-back-type secondary buffer storage device 20-1, the latest existent data of a write destination may be held in the other write-back-type secondary buffer storage device 20-2 instead of the secondary buffer storage device 20-1. In this case, if the address of the write destination belongs to the main storage device 10-2 for instance, the controller 20-3 of the secondary buffer storage device 20-1 requests the controller 11-4 of the work storage device 11-2 to provide the latest existent data of the write destination. Upon receipt of. this request, the controller 11-4 judges that the latest existent data of the write destination is held in the secondary buffer storage device 20-2 and the controller 11-4 requests the controller 20-4 of the secondary buffer storage device 20-2 to transfer the latest existent data of the write destination to the work storage device 11-2.

The controller 20-4 searches the secondary buffer storage 20-6 for the latest existent data of the write destination, and the controller 20-4 transfers the latest existent data to the work storage 11-6 of the work storage device 11-2. Then, the controller 11-2 transfers the latest existent data received in the work storage 11-6 to the secondary buffer storage 20-5 of the secondary buffer storage device 20-1. Then, after checking that the latest existent data has been received in the secondary buffer storage 20-5, the controller 20-3 of the secondary buffer storage device 20-1 carries out a write operation for replacing the latest existent data in the secondary buffer storage 20-5 with new data concerned.

In the conventional information processing illustrated in FIG. 8, since the secondary buffer storage devices 20-1 and 20-1 are of the write-back type as mentioned above, the latest existent data of a write destination is held in either one of the secondary buffer storage devices 20-1 and 20-2. When the instruction processors 13-1 and 13-2 attempt to rewrite data at the same address alternately in buffer storage device 12-1/12-2 in succession, the latest existent data of the write destination is transferred between the secondary buffer storage devices 20-1 and 20-2 repetitively. This disadvantageous behavior is referred to as a mutual invalidation phenomenon, which causes significant degradation in performance of the entire information processing system.

Also, since the write-back-type secondary buffer storage devices 20-1 and 20-2 are used in the conventional information processing system shown in FIG. 8, the latest existent data of a write destination must be held in the secondary buffer storage device 20-1 or 20-2 for rewriting. Therefore, in each of the secondary buffer storage devices, a certain memory area is required for holding the latest existent data of the write destination, causing a decrease in a residential probability (hit rate) of necessary read-out data in the secondary buffer storage.

### SUMMARY OF THE INVENTION

An object of the present invention is to provide an information processing system having a multi-level hierarchical storage arrangement including buffer storage devices, secondary buffer storage devices, work storage devices and main storage devices, wherein the entire information processing system performance is enhanced by preventing degradation in system performance due to occurrence of a mutual invalidation phenomenon and preventing a decrease in the hit rate of necessary read-out data in the secondary buffer storage.

Another object of the present invention is to provide a multi-level hierarchical storage device for use in an information processing system including a plurality of instruction processors and a plurality of main storage devices wherein the multi-level hierarchical storage device includes a plurality of hierarchically arranged storage devices of the write-through type which improve the performance of the information processing system.

In carrying out the invention and according to one aspect thereof, the foregoing objects are accomplished by providing an information processing system and a multi-level hierarchical storage device for use in the information processing system having a plurality of instruction processors and a plurality of main storage devices. The multi-level hierarchical storage device includes a first-cache storage device of a write-through type provided for each of the instruction processors, a second-cache storage device of a write-back type for each of the main storage devices, and a third-cache storage device of a write-through type provided between the first and second cache storage devices. The multilevel hierarchical storage device, particularly the use of the write-through type third-cache storage devices improves the performance of the information processing system relative to the conventional system.

Still further, the foregoing objects are accomplished by arranging the third “write-through-type” cache storage devices in a plural-level hierarchical structure to allow withdrawing at least one of the storage devices from system operations. Also the foregoing object can be accomplished by letting each of the instruction processors share a single unit of the third-cache storage device.

Still further yet, the foregoing objects are accomplished by providing first and third write through-type cache storage devices in the instruction processors or storage controllers.

### BRIEF DESCRIPTION OF THE DRAWINGS

The present invention will be more apparent from the following detailed description, when taken in conjunction with the accompanying drawings, in which:

FIG. 1 is a block diagram illustrating an information processing system configuration in a first embodiment of the present invention;

FIG. 2 is a block diagram illustrating an information processing system configuration in a second embodiment of the present invention;

FIGS. 3A and 3B are graphs illustrating execution time periods of load and store instructions;

FIGS. 4A-4E are diagrams illustrating differences in overhead for data transfer according to different schemes of secondary buffer storage and work storage;

FIGS. 5A-5E are diagrams illustrating differences in required throughput for data transfer between the secondary buffer storage and the work storage according to differences in the scheme of secondary buffer storage and the number of hierarchical storage levels;

FIGS. 6A and 6B are tables illustrating examples of transfer cycle paths and examples of miss rates in respective storage devices;

FIG. 7 is a block diagram illustrating a configuration of a conventional information processing system; and

FIG. 8 is a block diagram illustrating another configuration of a conventional information processing system.

### DESCRIPTION OF THE PREFERRED EMBODIMENTS

The present invention will now be described in detail through use of exemplary embodiments with reference to the accompanying drawings.

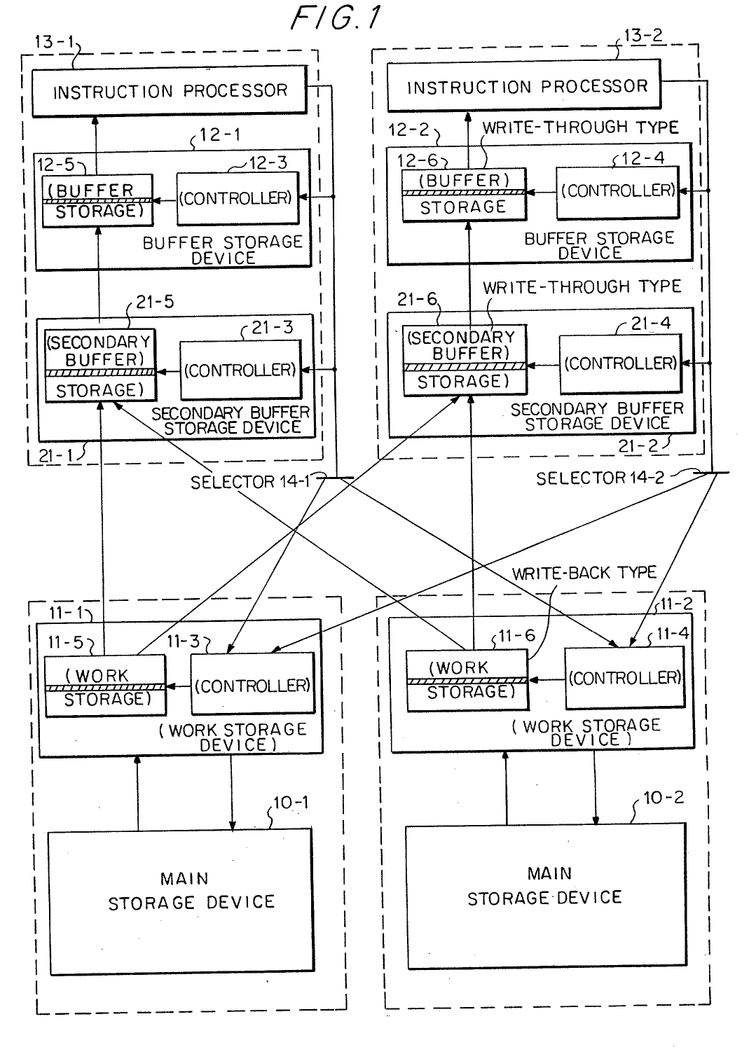

FIG. 1 illustrates a schematic block diagram of an information processing system configuration in a first preferred embodiment of this invention. Referring to FIG. 1, there are shown buffer storage controllers 12-3 and 12-4, buffer storages 12-5 and 12-6, secondary buffer storage devices 21-1 and 21-2, secondary buffer storage controllers 21-3 and 21-4, and secondary buffer storages 21-5 and 21-6. Other reference numerals in FIG. 1 are the same as those indicated in FIG. 8.

In the information processing system in the first preferred embodiment of this invention shown in FIG. 1, four-level hierarchical storage devices including secondary buffer storage are provided as in the conventional system shown in FIG. 8. The information processing system as configured in the first preferred embodiment of this invention includes instruction processors 13-1 and 13-2, buffer storage devices 12-1 and 12-2 serving as first-cache memories for respective instruction processors, secondary buffer storage devices 21-1 and 21-2 serving as third-cache memories for respective buffer storage devices 12-1 and 12-2, selectors 14-1 and 14-2 provided for respective secondary buffer storage devices 21-1 and 21-2, main storage devices 10-1 and 10-2, and work storage devices 11-1 and 11-2 serving as second-cache memories for respective main storage devices 10-1 and 10-2.

In the first preferred embodiment of this invention shown in FIG. 1, there are provided two instruction processors, two buffer storage devices, two secondary buffer storage devices, two work storage devices and two main storage devices. More than two of each of the devices may be arranged in carrying out the present invention. In the first preferred embodiment of the present invention, the secondary buffer storage devices 21-1 and 21-2 and the buffer storage devices 12-1 and 12-2 are of a write-through type.

In the information processing system illustrated in FIG. 1 the write-through-type secondary buffer storage devices 21-land 21-1 are added to the buffer storage devices 12-1 and 12-2 respectively. If necessary read-out data is not held in the buffer storage device 12-1 nor 12-2, the secondary buffer storage device 21-1 or 21-2 is referenced, thereby reducing a probability of having to perform an access to the work storage device 11-1 or 11-2 or further to the main storage device 10-1 or 10-2. Also, this arrangement makes it possible to prevent a mutual invalidation phenomenon that may occur in a conventional information processing system configured in a four-level hierarchical storage structure. Thus, the present invention improves the hit rate of necessary read-out data in the secondary buffer storage to enhance an access speed in the information processing system.

The following explains operations in the entire information processing system to be performed when the instruction processor 13-1 reads necessary data and when the instruction processors 13-1 and 13-2 write data simultaneously in the first preferred embodiment of this invention.

In an operation of reading necessary data by the instruction processor 13-1, if the necessary data is held in the buffer storage device 12-1, the necessary data is transferred from the buffer storage 12-5 of the buffer storage device 12-1 to the instruction processor 13-1. If the necessary data is not held in the buffer storage device 12-1 but is held in the secondary buffer storage device 21-1, the necessary data is transferred from the secondary buffer storage 21-5 of the secondary buffer storage device 21-1 to the buffer storage 12-5 of the buffer storage device 12-1 and then transferred from the buffer storage device 12-1 to the instruction processor 13-1.

If the data necessary for the instruction processor 13-1 is not held in the buffer storage device 12-1 nor the secondary buffer storage device 21-1, the necessary data is transferred from the work storage 11-5 of the work storage device 11-1 or the work storage 11-6 of the work storage device 11-2 to the secondary buffer storage 21-5 of the secondary buffer storage device 21-1 according to the address information. Then, the necessary data is transferred from the secondary buffer storage device 21-1 to the instruction processor 13-1 via the buffer storage device 12-1.

If the data necessary for the instruction processor 13-1 is not held even in the work storage device 11-1 nor 11-2, the necessary data is provided from the associated main storage device 10-1 or 10-2 to the work storage 11-5 of the work storage device 11-1 or to the work storage 11-6 of the work storage device 11-2. Thereafter, the necessary data is transferred from the work storage device 11-1 or 11-2 to the instruction processor 13-1 via the secondary buffer storage device 21-1 and the buffer storage device 12-1.

In an operation of writing data by each of the instruction processors 13-1 and 13-2 simultaneously, the data to be written is sent to the controller 12-3 or 12-4 of the associated buffer storage device 12-1 or 12-2 and to the controller 21-3 or 21-4 of the secondary buffer storage device 21-1 or 21-2. Then, if a copy of a write destination address of the write-in data in the main storage device 10-1 or 10-2 is found in the buffer storage device 12-1 or 12-2, the controller 12-3 or 12-4 of the buffer storage device 12-1 or 12-2 enters the write-in data in the buffer storage 12-5 or 12-6 of the buffer storage device 12-1 or 12-2. If the copy of the write destination address is not found in the buffer storage device 12-1 or 12-2, the write-in data is ignored through interpretation that the writing thereof is not necessary.

In the same manner, if a copy of the write destination address of the write-in data in the main storage device 10-1 or 10-2 is found in the secondary buffer storage 21-1 or 21-2, the controller 21-3 or 21-4 of the secondary buffer storage device 21-1 or 21-2 enters the write-in data in the secondary buffer storage 21-5 or 21-6 of the secondary buffer storage device 21-1 or 21-2. If the copy of the write destination address is not found in the secondary buffer storage device 21-1 or 21-2, the write-in data is ignored through interpretation that the writing thereof is not necessary.

In the first preferred embodiment of present invention, the write-through-type secondary buffer storage devices 21-1 and 21-2 are used and the single-copy method is employed for the work storage devices 11-1 and 11-2. The selector 14-1 or 14-2 associated with the secondary buffer storage device 21-1 or 21-1 judges which of the main storage devices 10-1 and 10-2 has the write destination address of the write-in data concerned, and then the write-in data is sent to the controller 11-3 or 11-4 of the work storage device 11-1 or 11-2 corresponding to the main storage device identified in the judgment.

Receiving the write-in data, the controller 11-3 or 11-4 of the work storage device 11-1 or 11-2 checks whether the copy of the write destination address of the write-in data in the main storage device 10-1 or 10-2 is found in the work storage device 11-1 or 11-2. If the copy of the write destination address is found in the work storage device 11-1 or 11-2, the write-in data is entered in the work storage device 11-1 or 11-2. If not, the copy of the write destination address is transferred from the main storage device 10-1 or 10-2 to the work storage device 11-1 or 11-2 and then the write-in data is entered in the work storage device 11-1 or 11-2.

As can be seen from the explanation given above, in the first preferred embodiment of the present invention, even if the instruction processors 13-1 and 13-2 attempt to write data simultaneously, a mutual invalidation phenomenon does not occur between the secondary buffer storage devices 21-1 and 21-2. Also, since it is not required for each of the secondary buffer storage devices 21-1 and 21-1 to always hold a copy of a write destination address assigned in each of the main storage devices 10-1 and 10-2. Therefore, in the first preferred embodiment of the present invention, a residential probability (hit rate) of necessary read-out data in each of the secondary buffer storage devices 21-1 and 21-2 can be increased, making it possible to enhance information processing performance of the entire system.

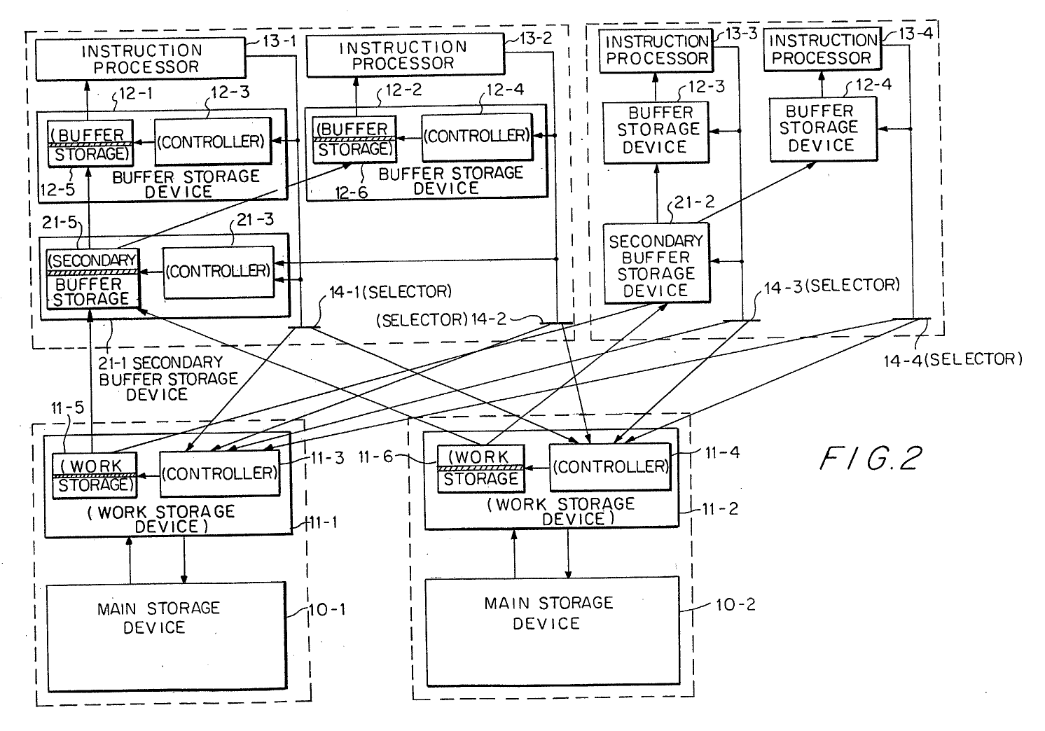

FIG. 2 illustrates a schematic block diagram of an information processing system configuration of a second preferred embodiment of the present invention. Referring to FIG. 2, there are shown in addition to the elements shown in FIG. 1 instruction processors 13-3 and 13-4, buffer storage devices 12-3 and 12-4, and selectors 14-3 and 14-4. Other reference numerals are the same as those indicated in FIG. 1.

In the information processing system in the second preferred embodiment of this invention illustrated in FIG. 2, four-level hierarchical storage devices including secondary buffer storage are provided. The information processing system in the second preferred embodiment of the present invention includes instruction processors 13-1 to 13-4, buffer storage devices 12-1 to 12-4 provided for respective processors, secondary buffer storage devices 21-1 and 21-2 provided in common to two buffer storages, selectors 14-1 to 14-4 provided for respective secondary buffer storage devices and buffer storage devices, main storage devices 10-1 and 10-2, and work storage devices 11-1 and 11-2 provided for respective main storage devices.

In the second preferred embodiment of the present invention illustrated in FIG. 2, there are provided four instruction processors. Also, unlike the first preferred embodiment illustrated in FIG. 1 wherein two secondary buffer storage devices serving as third-cache memories are provided for two buffer storage devices respectively, the second preferred embodiment of the present invention has an arrangement that the one secondary buffer storage device 21-1 is provided for a pair of buffer storage devices 12-1 and 12-2 and the other secondary buffer storage device 21-2 is provided for a pair of buffer storage devices 12-3 and 12-4 which are associated with instruction processors 13-3 and 13-4 respectively.

In the information processing system in the second preferred embodiment of the present invention, each of the secondary buffer storage devices is shared by a plurality of buffer storage devices. In this arrangement, the hit rate of necessary data in the secondary buffer storage can be improved by increasing the capacity of the secondary buffer storage in each of the secondary buffer storage devices.

The following describes in detail advantageous effects of the information processing system configured in the first preferred embodiment of this invention.

The information processing system illustrated in FIG. 1 has a four-level hierarchical storage arrangement. In execution of a load instruction for reading a part of contents stored in the main storage. device to one of registers of the instruction processor, necessary data is transferred to the instruction processor from the buffer storage device, secondary buffer storage device, work storage device or main storage device. Therefore, in the information processing system illustrated in FIG. 1, when each instruction processor carries out the load instruction, the execution time thereof can be classified into four kinds.

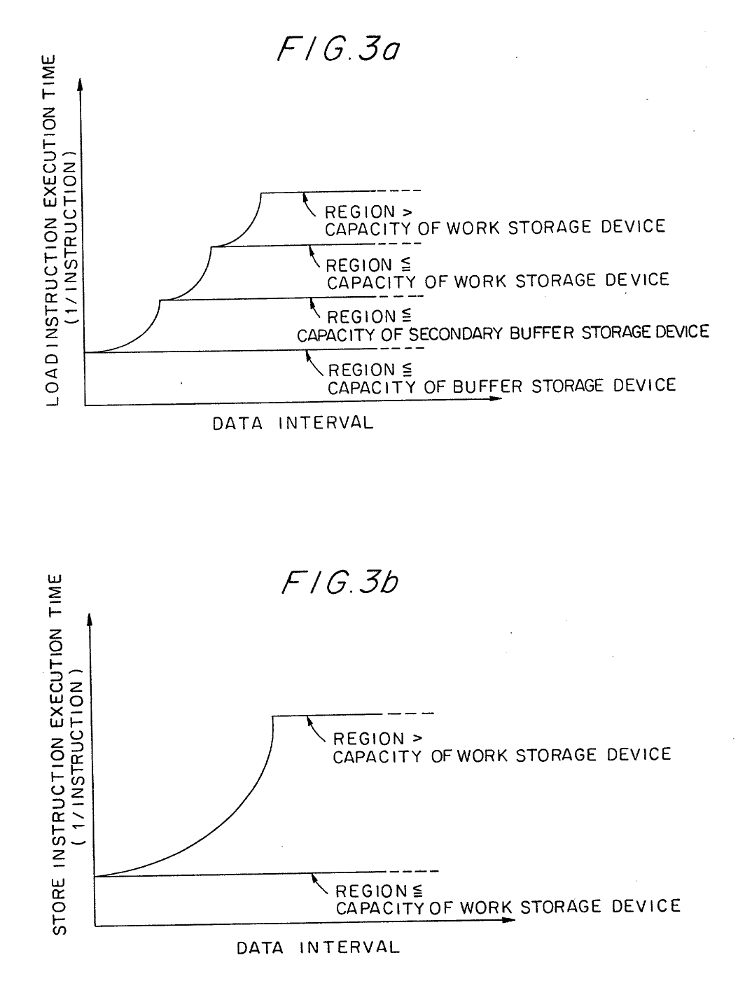

FIGS. 3A and 3B illustrate execution time periods of the load and store instructions, which are explained below.

Referring to FIG. 3A, there are indicated load instruction execution time periods in the information processing system illustrated in FIG. 1. When the load instruction is carried out repetitively at certain intervals for different addresses in a certain region of the main storage device, the execution time thereof varies as illustrated in FIG. 3A. In this graph, load time periods taken for different sizes of reference regions are plotted with the execution time as the ordinate of the graph and data interval as abscissa of the graph.

As can be seen from the graph illustrated in FIG. 3A, as long as the size of the region of the main storage device for which the load instruction is carried out does not exceed the capacity of each of the buffer storage device, secondary buffer storage device and work storage device, an execution time of the load instruction is constant on each of these storage devices. If the size of the region of the main storage device for which the load instruction is carried out exceeds the capacity of each of these storage devices, relevant data is transferred from the main storage device and therefore the execution time of the load instruction becomes constant according to a time required for data transfer from the main storage device to the instruction processor.

In execution of a store instruction for writing data from one of the registers of the instruction processor to a certain location in the main storage device, a time required for storing data is constant on the storage hierarchical levels of the buffer storage and secondary buffer storage devices since these devices are of the write-through type. It is necessary for evaluation to measure only a time required for storing data in the write-back-type work storage device and a time required for transferring the data back to the main storage device. FIG. 3B illustrates a graph in which store time periods are plotted in the same manner as in FIG. 3A.

The advantageous effects in the above-mentioned embodiments of the present invention are described in terms of the following aspects: (i) overhead for data transfer required by instruction processor is reduced, and (ii) required throughput for data transfer between secondary buffer storage and work storage devices is increased.

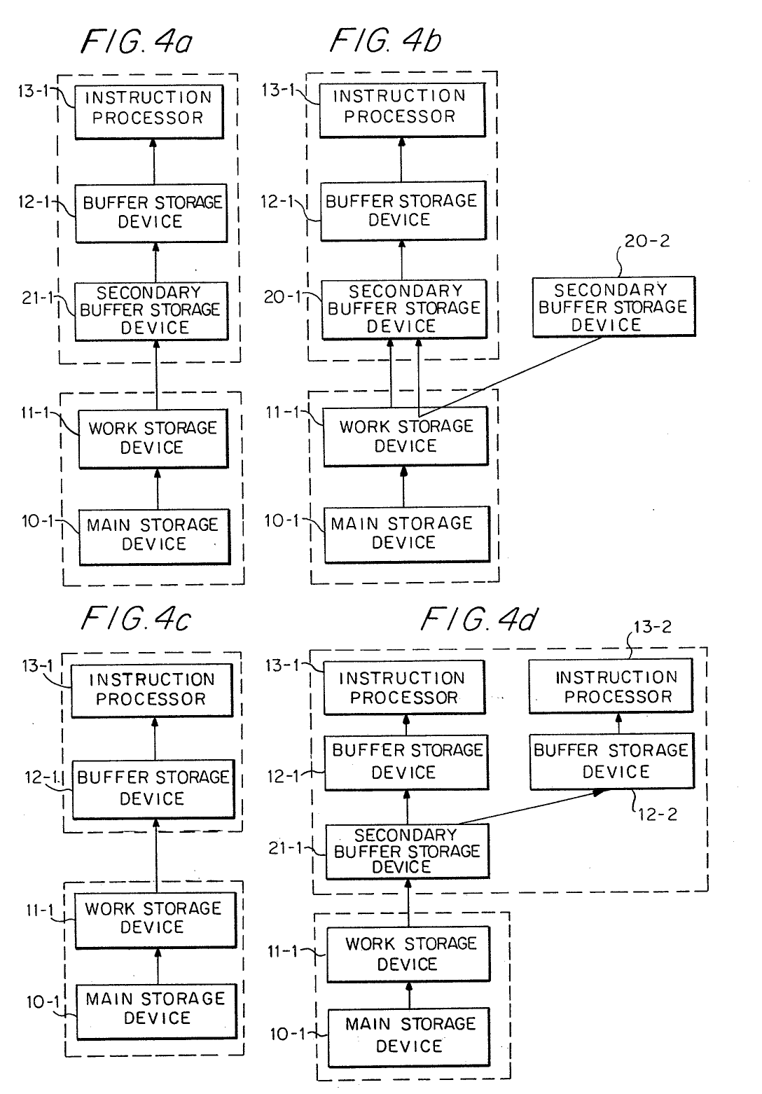

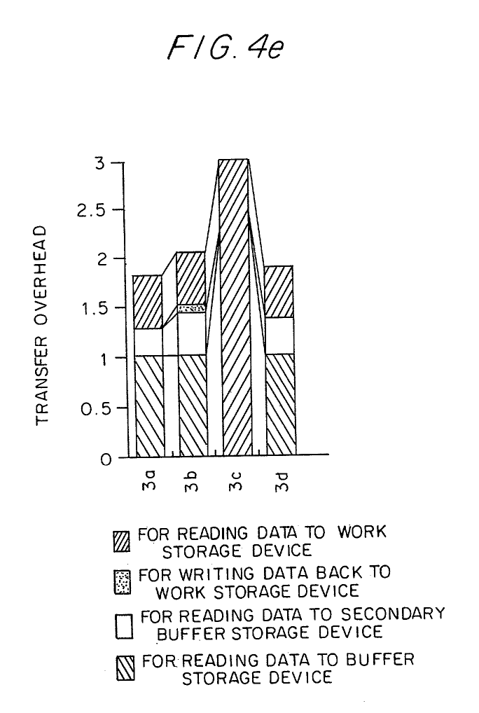

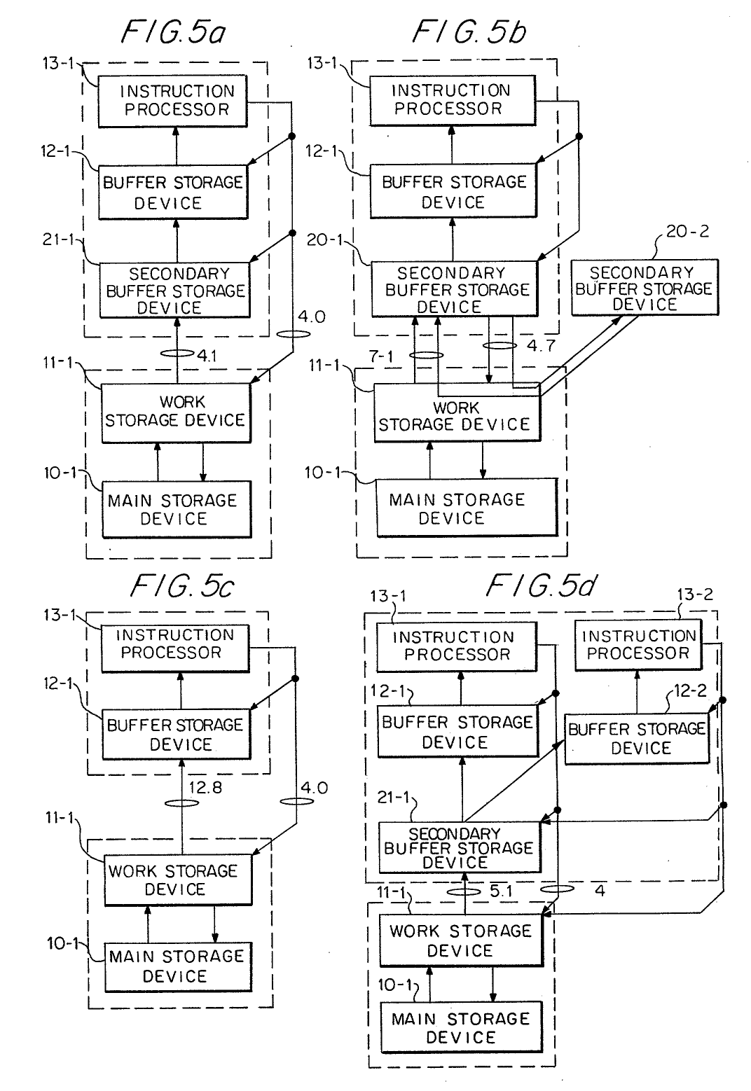

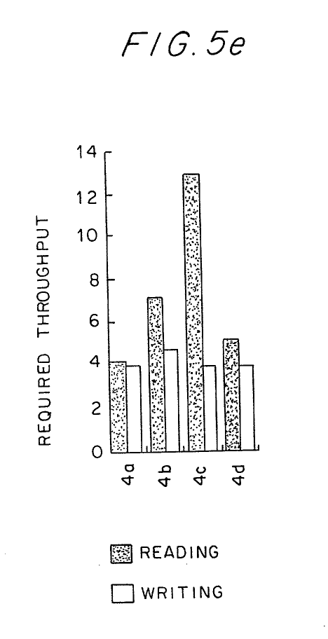

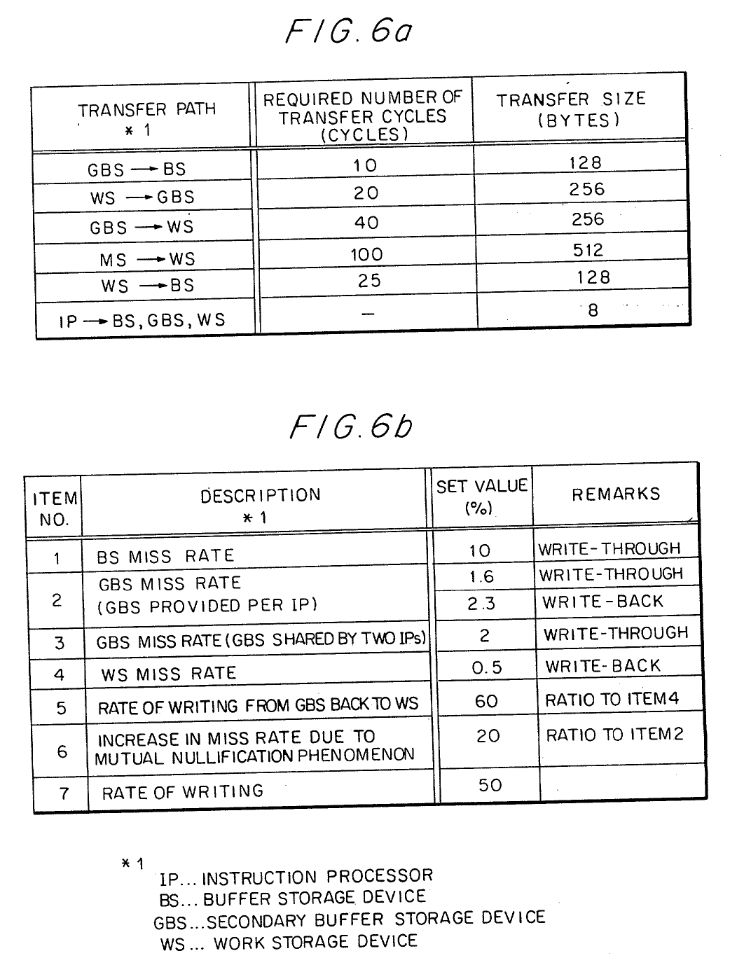

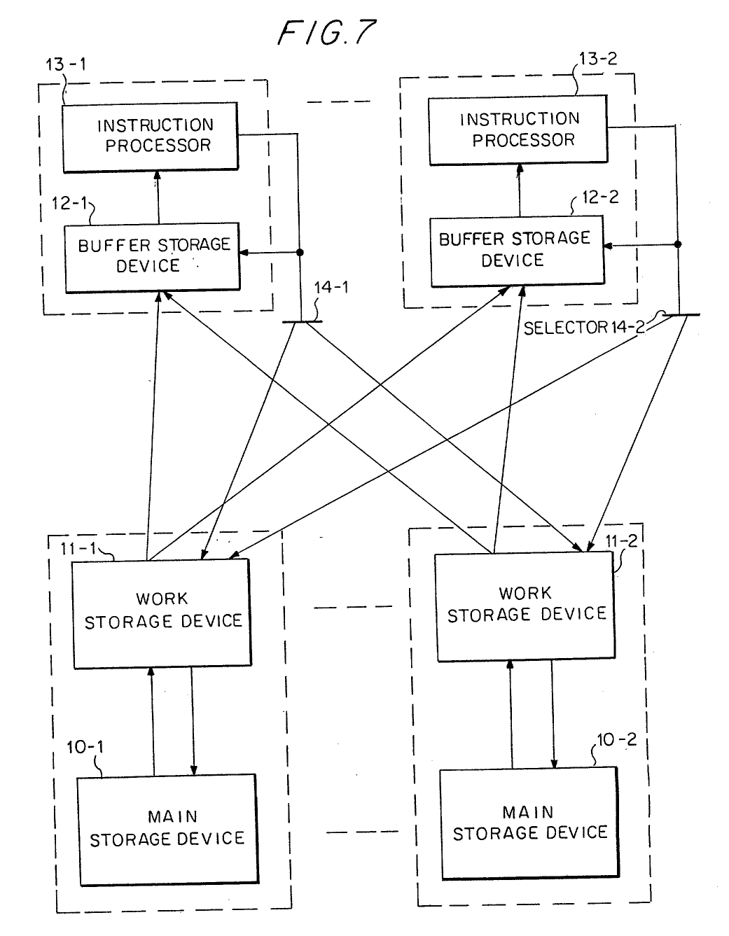

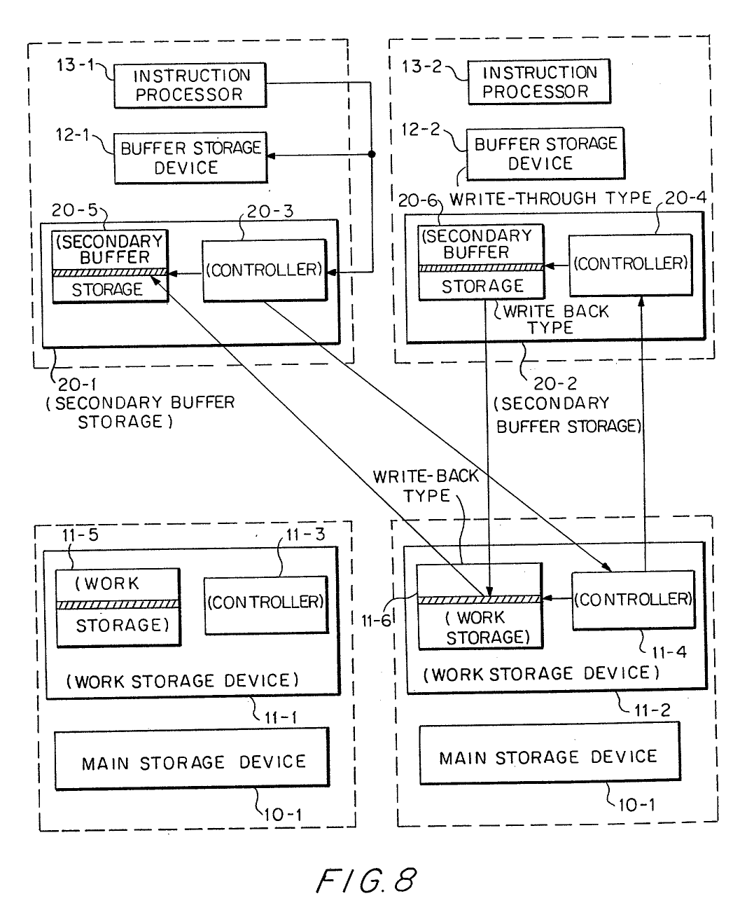

FIGS. 4A-4E are presented for explanation of differences in transfer overhead among the information processing systems having three-level and four-level hierarchical storage structures according to different schemes of secondary buffer and work storage devices. FIGS. 5A-5E are presented for explanation of differences in required throughput for data transfer between the secondary buffer and work storage devices among the information processing systems having three-level and four-level hierarchical storage structures 25 according to differences in the scheme secondary buffer storage and the number of hierarchical storage levels. FIGS. 6A and 6B illustrate examples of transfer cycle and line size requirements for respective transfer paths, together with examples of miss rates in respective storage devices.

(i) Overhead for Data Transfer Required by Instruction Processor (Hereinafter Just Referred to as Transfer Overhead):

Referring to FIG. 4A, there is shown an information processing system scheme in the first preferred embodiment of this invention wherein the write-through-type buffer storage device 12-1 and the write-through-type secondary buffer storage device 21-1 are provided and the four-level hierarchical storage structure is formed with the buffer storage and secondary buffer storage devices arranged for each instruction processor. In this system scheme, transfer overhead is represented by sum total of “miss rate in each hierarchical level of storage”×“the number of transfer cycles required between two hierarchical levels of storage”.

That is, in the information processing system scheme illustrated in FIG. 4A, a value of transfer overhead is calculated using values indicated in FIGS. 6A and 6B as follows:

10×10%+20×1.6%+100×0.5%=1.8

(Unit: cycles/instruction)

Note that, in FIGS. 6A and 6B each number of machine cycles for data transfer indicates a predictive value in the information processing system with enhanced machine-cycle performance, and each miss rate in buffer storage and other parameters indicate values based on actual measurement.

Referring to FIG. 4B, there is shown a conventional information processing system scheme wherein the write through-type buffer storage device 12-1 and the writeback-type secondary buffer storage device 20-1 are provided and the four-level hierarchical storage structure is formed with the buffer storage and secondary buffer storage devices arranged for each instruction processor. In this system scheme, transfer overhead is larger than that in the scheme shown in FIG. 4A due to an increase in the miss rate because of the write-back type of secondary buffer storage and possible occurrences of mutual invalidation phenomenon.

In the information processing system scheme shown in FIG. 4B, a value of transfer overhead is calculated in the same manner as mentioned above as follows:

10×10%+20×2.3%+20×2.3%×0.2+100×0.5%=2.1

(Unit: cycles/instruction)

In this calculation of transfer overhead, an increase in the miss rate due to possible occurrences of mutual invalidation phenomenon is assumed to be 20% because of the following reason: It is predicted that, on occurrence of a miss of necessary data in the write-back-type secondary buffer storage device, a residential probability thereof in the other secondary buffer storage device is 20%.

Referring to FIG. 4C, there is illustrated a conventional information processing system scheme wherein the write through-type buffer storage device 12-1 is provided and the three-level hierarchical storage structure is formed with the buffer storage device arranged for each instruction processor. In this system scheme, a value of transfer overhead is calculated in the same manner as in FIG. 4A as follows:

25×10%+100×0.5%=3.0

Referring to FIG. 4D, there is illustrated an information processing system scheme in the second preferred embodiment of this invention wherein the write-through-type buffer storage devices 12-1 and 12-2 and the write-through-type secondary buffer storage device 21-1 are provided and the four-level hierarchical storage structure is formed with each of the buffer storage devices arranged for each instruction processor and the secondary buffer storage device arranged for sharing by two instruction processors. In this example, the memory capacity of the secondary buffer storage device 21-1 is the same as that shown in FIG. 4A.

In this information processing system scheme shown in FIG. 4D, a value of transfer overhead is calculated as indicted below in consideration of an increase in the miss rate due to sharing of the secondary buffer storage device 21-1 by the two instruction processors as follows:

10×10%+20×2.0%+100×0.5%=1.9

FIG. 4E illustrates a graph indicating differences in transfer overhead among the information processing system schemes mentioned above. As indicated in this graph, there is a significant difference in transfer overhead at the hierarchical level of the secondary buffer storage device in comparison between the system scheme shown in FIG. 4B and the system schemes shown in FIGS. 4A and 4D.

Having described transfer overhead in each preferred embodiment of the present invention, it is obvious that the arrangement of write-through-type secondary buffer storage can suppress occurrences of mutual invalidation phenomenon to reduce transfer overhead.

(ii) Required Throughput for Data Transfer between Secondary Buffer Storage and Work Storage Devices (Hereinafter Just Referred to as Required Throughput):

Referring to FIG. 5A, there is illustrated an information processing system scheme in the first preferred embodiment of the present invention wherein the write-through-type buffer storage device 12-1 and the write-through-type secondary buffer storage device 21-1 are provided and the four-level hierarchical storage structure is formed with the buffer storage and secondary buffer storage devices arranged for each instruction processor.

Required throughput is represented by “miss rate”×“size of transfer fine between storage devices”. Therefore, in the information processing system scheme shown in FIG. 5A, a value of required throughput in transfer from the work storage device 11-1 to the secondary buffer storage device 21-1 is calculated using values indicated in FIGS. 6A and 6B as follows:

256×1.6%=4.1

(Unit: bytes/instruction)

On the other hand, required throughput in transfer from the secondary buffer storage device 21-1 to the work storage device 11-1 is equal to that in writing from the instruction processor 13-1 to the work storage device 11-1 since the secondary buffer storage device 21-1 is of the write-through type. Under condition that the line width in writing is eight bytes according to FIG. 6A and the write rate is 50% (1/instruction) according to FIG. 6B, a value of required throughput in transfer from the secondary buffer storage device 21-1 to the work storage device 11-1 is calculated as follows:

8×50%=4.0

(Unit: bytes/instruction)

Referring to FIG. 5B, there is illustrated a conventional information processing system scheme wherein the write through-type buffer storage device 12-1 and the writeback-type secondary buffer storage device 20-1 are provided for each instruction processor.

In the information processing system scheme illustrated in FIG. 5B, a value of required throughput in transfer from the work storage device 11-1 to the secondary buffer storage device 20-1 is calculated in consideration of an increase in the miss rate due to holding of date of write destination in the secondary buffer storage device of the write-back type (unlike the write through-type secondary buffer storage device in the system scheme shown in FIG. 5A, an increase in required throughput due to mutual transfer phenomenon between the secondary buffer storage devices 20-1 and 20-2, and a multiplier factor of 0.2 empirically predicted for required throughput (refer to FIG. 6B as follows:

256×2.3%+256×2.3%×0.2=7.1

(Unit: bytes/instruction)

On the other hand, required throughput in transfer from the secondary buffer storage device 20-1 to the work storage device 11-1 is represented as indicated below since the secondary buffer storage device 20-1 is of the write-back type; “required throughput in write-back from secondary buffer storage device 20-1 to work storage device 11-1 involved in read-out data transfer from work storage device 11-1 to secondary buffer storage device 20-1”+“required throughput due to mutual invalidation phenomenon between secondary buffer storage devices 20-1 and 20-2”.

According to the values indicated in FIG. 6B, the first term is approximately 60% of required throughput in data read-out from the work storage device 11-1 to the secondary buffer storage device 20-1, and the second term is approximately 20% of required throughput in data read-out from the work storage device 11-1 to the secondary buffer storage device 20-1. Therefore, a value of required throughput in transfer from the secondary buffer storage device 20-1 to the work storage device 11-1 is calculated as follows:

256×2.3%×0.6+256×2.3%×0.2=4.7

(Unit: bytes/instruction)

Consequently, although the foregoing conventional information processing system scheme is provided with the write-back-type secondary buffer storage device 20-1 for the purpose of reducing required throughput in data transfer from the secondary buffer storage device 20-1 to the work storage device 11-1, the write-back-type arrangement of the secondary buffer storage makes the miss rate larger than that in the “write-through-type arrangement of the secondary buffer storage and causes occurrences of mutual invalidation phenomenon. That is, the write-through-type arrangement of the secondary buffer storage is more advantageous than the write-back-type arrangement of the secondary buffer storage.

Referring to FIG. 5C, there is shown a conventional information processing system scheme wherein the write through-type buffer storage device 12-1 is provided for each instruction processor in the three-level hierarchical storage structure.

In the conventional information processing system scheme illustrated in FIG. 5C, a value of required throughput in transfer from the work storage device 11-1 to the buffer storage device 21-1 is calculated in the same manner as for the system scheme shown in FIG. 5A as follows:

128×10%=12.8

Also, since the write-through-type buffer storage device is used, a value of required throughput in transfer from the buffer storage device 21-1 to the work storage device 11-1 is calculated similarly to the system scheme shown in FIG. 5 (a) as follows:

8×50%=4

Referring to FIG. 5D, there is illustrated an information processing system scheme in the second preferred embodiment of the present invention wherein the write-through-type buffer storage devices 12-1 and 12-2 and the write-through-type secondary buffer storage device 21-1 are provided and the four-level hierarchical storage structure is formed with each of the buffer storage devices arranged for each instruction processor and the secondary buffer storage device arranged for sharing by two instructor processors. In this example, the memory capacity of the secondary buffer storage device 21-1 is the same as that shown in FIG. 5A.

In this information processing system scheme illustrated in FIG. 5D, a value of required throughput in transfer from the work storage device 11-1 to the secondary buffer storage device 21-1 is calculated as indicated below in consideration of an increase in the miss rate due to sharing of the secondary buffer storage device 21-1 by the two instruction processors:

256×2.0%=5.1

Also, since the write-through-type secondary buffer storage device is used, a value of required throughput in transfer from the secondary buffer storage device 21-1 to the work storage device 11-1 is calculated the same as for the system scheme shown in FIG. 5A as follows:

8×50%=4

FIG. 5E is a graph illustrating the results of the above-mentioned calculations on required throughput. As can be seen from this graph, the required throughput in reading and writing data in each of the exemplary preferred embodiments of the present invention is more advantageous then that in the conventional system schemes.

While transfer overhead and required throughput in the present invention in the preferred embodiments having the four-level hierarchical storage structure have been described, it is to be understood that transfer overhead and required throughput can be reduced further by increasing the number of hierarchical storage levels to five, six, and so on.

In carrying out the present invention, write through-type secondary buffer storage devices exemplified in the foregoing preferred embodiments may be arranged at a plurality of hierarchical buffer storage levels in an information processing system. In this arrangement, on occurrence of a failure in any one of or in a plurality of hierarchically structured buffer storage devices, a failed buffer storage device or devices can be withdrawn from the information processing system configuration to allow operations thereof using a reduced number of hierarchical buffer storage levels.

Also, in practicing the present invention, the buffer storage device mentioned above and one or plural hierarchical levels of the secondary buffer storage devices may be included in a structure of the instruction processor or storage controller.

Furthermore, in practicing the present invention, the buffer storage device mentioned above and one or plural hierarchical levels of the secondary buffer storage devices may be arranged to hold a part of instructions and a part of data stored in the main storage device.

Still more, while there has been described the second preferred embodiment wherein the secondary buffer storage device is shared by two instruction processors, the secondary buffer storage device may be arranged for sharing by three or more instruction processors.

According to the present invention, in the information processing system having a multiple-level hierarchical storage arrangement including buffer storage devices, secondary buffer storage devices, work storage devices and main storage devices, degradation in the entire system performance due to occurrence of the mutual invalidation phenomenon and decrease in the hit rate of necessary read-out data in the secondary buffer storage can be eliminated to enable higher-speed processing of information in the system.

While the present invention has been described in detail and pictorially in the accompanying drawings it is not limited to such details since many changes and modifications recognizable to those of ordinary skill in the art may be made to the invention without departing from the spirit and the scope thereof.

We claim:

1. A multi-level hierarchical storage device for use in an information processing system having a plurality of instruction processors and a plurality of main storage devices, said multi-level hierarchical storage device comprising:
a first-cache storage device of a write-through type provided for each instruction processor;
a second-cache storage device of a write-back type provided for each main storage device; and
a third-cache storage device of a write-through type provided between said first-cache storage device and said second-cache storage device.

2. A multi-level hierarchical storage device according to claim 1, wherein said third-cache storage device is a single unit shared by each of said instruction processors

3. A multi-level hierarchical storage device according to claim 1, wherein a first and a third cache storage device are provided in each of said instruction processors.

4. A multi-level hierarchical storage device according to claim 1, wherein each storage device includes a buffer storage and a controller for controlling said buffer storage.

5. A multi-level hierarchical storage device according to claim 2, wherein each storage device includes a buffer storage and a controller for controlling said buffer storage.

6. A multi-level hierarchical storage device according to claim 4, wherein said controller associated with said buffer storage of said third-cache storage device causes retrieval of data from said buffer storage of said third-cache storage device when said data does not exist in said first-cache storage device and said controller associated with said buffer storage of a second-cache storage device causes retrieval of said data from said buffer storage of said second-cache storage device when said data does not exist in said first-cache storage device and said third-cache storage device.

7. A multi-level hierarchical storage device according to claim 5, wherein said controller associated with said buffer storage of said third-cache storage device causes retrieval of data from said buffer storage of said third-cache storage device when said data does not exist in said first-cache storage device and said controller associated with said buffer storage of a second-cache storage device causes retrieval of said data from said buffer storage of said second cache storage device when said data does not exist in said first-cache storage device and said third-cache storage device.

8. A multi-level hierarchical storage device according to claim 1, wherein said third-cache storage device is provided between said first-cache storage device and said second-cache storage device at each level of said multi-level hierarchical storage device, and
wherein said third-cache storage device provided in at least one of said levels is withdrawable.

9. An information processing system comprising:
a plurality of main storage devices;
a plurality of instruction processors which read/write data to/from said main storage devices; and
a plurality of multi-level hierarchical storage device;
wherein each multi-level hierarchical storage device comprises:
a first-cache storage device of a write-through type provided for one of said instruction processors,
a second-cache storage device of a write-back type provided for one of said main storage devices, and
a third-cache storage device of a write-through type provided between said first-cache storage device and said second-cache storage device.

10. An information processing system according to claim 9, wherein said third-cache storage device is a single unit shared by each of said instruction processors

11. An information processing system according to claim 9, wherein a first and a third cache storage device are provided in each of said instruction processors.

12. An information processing system according to claim 9, wherein each storage device includes a buffer storage and a controller for controlling said buffer storage.

13. An information processing system according to claim 10, wherein each storage device includes a buffer storage and a controller for controlling said buffer storage.

14. An information processing system according to claim 12, wherein said controller associated with said buffer storage of said third-cache storage device causes retrieval of data from said buffer storage of said third-cache storage device when said data does not exist in said first-cache storage device and said controller associated with said buffer storage of a second-cache storage device causes retrieval of said data from said buffer storage of said second-cache storage device when said data does not exist in said first-cache storage device and said third-cache storage device.

15. An information processing system according to claim 13, wherein said controller associated with said buffer storage of said third-cache storage device causes retrieval of data from said buffer storage of said third-cache storage device when said data does not exist in said first-cache storage device and said controller associated with said buffer storage of a second-cache storage device causes retrieval of said data from said buffer storage of said second cache storage device when said data does not exist in said first-cache storage device and said third-cache storage device.

16. An information processing system according to claim 9, wherein said third-cache storage device is provided between said first-cache storage device and said second-cache storage device at each level of said multi-level hierarchical storage device, and
wherein said third-cache storage device provided in at least one of said levels is withdrawable.

17. An information processing system comprising:
at least one instruction processor; and
at least one storage controller,
wherein said instruction processor is provided with plural hierarchical levels of cache storage devices, each being of a write-through type.

18. An information processing system comprising:
at least one instruction processor; and
at least one storage controller,
wherein said storage controller is provided with plural hierarchical levels of cache storage devices, each being of a write-through type.

19. An information processing system comprising:
a plurality of main storage devices;
a plurality of instruction processors which load/store data from/to said main storage devices; and
a plurality of multi-level hierarchical storage devices, each level of each multi-level hierarchical storage device being of a write-through type,
wherein when an instruction processor carries out a load instruction for a region of a main storage device and the size of the region of the main storage device does not exceed a capacity of each level of a multi-level hierarchical storage device, and execution time of said load instruction is constant for each level of said multi-level hierarchical storage device, multi-level hierarchical storage device being provided between said instruction processor and said main storage device.

20. An information processing system according to claim 19, wherein each multi-level hierarchical storage device comprises:
a first-cache storage device of a write-through type provided for one of said instruction processors;
a second-cache storage device of a write-back type provided for one of said main storage devices; and
a third-cache storage device of a write-through type provided between said first-cache storage device and said second-cache storage device.

21. An information processing system according to claim 20, wherein said third-cache storage device is a single unit shared by each of said instruction processors

22. An information processing system according to claim 20, wherein a first and a third cache storage device are provided in each of said instruction processors.

23. An information processing system according to claim 20, wherein each storage device includes a buffer storage and a controller for controlling said buffer storage.

24. An information processing system according to claim 21, wherein each storage device includes a buffer storage and a controller for controlling said buffer storage.

25. An information processing system according to claim 23, wherein said controller associated with said buffer storage of said third-cache storage device causes retrieval of data from said buffer storage of said third-cache storage device when said data does not exist in said first-cache storage device and said controller associated with said buffer storage of a second-cache storage device causes retrieval of said data from said buffer storage of said second-cache storage device when said data does not exist in said first-cache storage device and said third-cache storage device.

26. An information processing system according to claim 24, wherein said controller associated with said buffer storage of said third-cache storage device causes retrieval of data from said buffer storage of said third-cache storage device when said data does not exist in said first-cache storage device and said controller associated with said buffer storage of a second-cache storage device causes retrieval of said data from said buffer storage of said second cache storage device when said data does not exist in said first-cache storage device and said third-cache storage device.

27. An information processing system according to claim 20, wherein said third-cache storage device is provided between said first-cache storage device and said second-cache storage device at each level of said multi-level hierarchical storage device, and
wherein said third-cache storage device provided in at least one of said levels is withdrawable.

28. An information processing system comprising:
a plurality of main storage devices;
a plurality of instruction processors which load/store data from/to said main storage devices; and
a plurality of multi-level hierarchical storage devices, each level of each multi-level hierarchical storage device being of a write-through type,
wherein when an instruction processor carries out a store instruction for storing data to a location in a main storage device an execution time of said store instruction is constant for each level of a multi-level hierarchical storage device said multi-level hierarchical storage device being provided between said instruction processor and said main storage device.

29. An information processing system according to claim 28, wherein each multi-level hierarchical storage device comprises:
a first-cache storage device of a write-through type provided for one of said instruction processors;
a second-cache storage device of a write-back type provided for one of said main storage devices; and
a third-cache storage device of a write-through type provided between said first-cache storage device and said second-cache storage device.

30. An information processing system according to claim 29, wherein said third-cache storage device is a single unit shared by each of said instruction processors

31. An information processing system according to claim 29, wherein a first and a third cache storage device are provided in each of said instruction processors.

32. An information processing system according to claim 29, wherein each storage device includes a buffer storage and a controller for controlling said buffer storage.

33. An information processing system according to claim 30, wherein each storage device includes a buffer storage and a controller for controlling said buffer storage.

34. An information processing system according to claim 32, wherein said controller associated with said buffer storage of said third-cache storage device causes retrieval of data from said buffer storage of said third-cache storage device when said data does not exist in said first-cache storage device and said controller associated with said buffer storage of a second-cache storage device causes retrieval of said data from said buffer storage of said second-cache storage device when said data does not exist in said first-cache storage device and said third-cache storage device.

35. An information processing system according to claim 33, wherein said controller associated with said buffer storage of said third-cache storage device causes retrieval of data from said buffer storage of said third-cache storage device when said data does not exist in said first-cache storage device and said controller associated with said buffer storage of a second-cache storage device causes retrieval of said data from said buffer storage of said second cache storage device when said data does not exist in said first-cache storage device and said third-cache storage device.

36. An information processing system according to claim 29, wherein said third-cache storage device is provided between said first-cache storage device and said second-cache storage device at each level of said multi-level hierarchical storage device, and
wherein said third-cache storage device provided in at least one of said levels is withdrawable.
